(19) United States
(12) Patent Application Publication
(10) Pub. No.: US 2008/0252601 A1
(43) Pub. Date: Oct. 16, 2008

(54) Computer Peripheral with Touch Screen Capability

(76) Inventor: Mark A. Boys, Aromas, CA (US)

Correspondence Address: CENTRAL COAST PATENT AGENCY, INC, 3 HANGAR WAY SUITE D, WATSONVILLE, CA, 95076, US

(21) Appl. No.: 11/733,343

(22) Filed: Apr. 10, 2007

(51) Int. Cl. G06F 13/38

(52) U.S. Cl. 345/163; 345/173

(57) ABSTRACT

A computing system for calculating has a host computing appliance able to communicate with a computer peripheral, a computer peripheral having there on a touch screen user interface and an activation control for activating and deactivating the touch screen interface.

### CROSS-REFERENCE TO RELATED APPLICATIONS

NA

### BACKGROUND OF THE INVENTION

1. Field of the Invention

The present invention is in the field of computers and computer peripherals and pertains particularly to a computer peripheral with touch screen capability.

2. Discussion of the State of the Art

In the field of computing, a mouse is often used as an input device for controlling the display of a computing appliance like a personal computer. There are serial mice and laser mice available that are typically used with a mouse pad that the input device rests on.

The inventor is aware of a mouse pad that has a built comprising a universal serial bus (USB) hub. In this device, a USB hub is integrated with the mouse pad. The hub portion has 4 USB ports and a USB connector cable to connect the device to a USB port on a computing appliance. In the hub housing of the device, there are light-emitting diodes that light up when the device is plugged into a port on the computing appliance and deriving power from the appliance through the USB cable as is generally known in the art. The pad portion is a transparent polymer body with a solid coating on either side that forms the mouse pad surface. When lit up, the edges of the mouse pad are illuminated so that the pad is easily visible in low light conditions.

The device described above is often used with a laptop-computing device in conjunction with a USB keyboard so that the system can be used more in the fashion of a desktop computing device. One problem with typical laptop computing systems is that there are no physical interfaces on the computer itself that support 10-key functions. An external keyboard might include 10-key capability but it is not a robust or dedicated keypad that would be provided in a separate 10-key system. Often users use a separate 10-key system in addition to their computer system when doing business calculations and the like.

Many users often use their laptops in mobile environments and therefore do not wish to carry extra peripherals or separate computing systems. In this case, many users who are touch-pad challenged do attach a USB mouse to the laptop so that they have familiar mouse functions similar to a desktop that they are more familiar with.

It has occurred to the inventor that a mouse pad could be provided as a USB peripheral that includes a complete 10-key capability so that users may easily access and operate familiar 10-key functions while using their laptop in a stationary or mobile environment.

### SUMMARY OF THE INVENTION

The inventor provides a computing system for calculating. The computing system includes a host computing appliance able to communicate with a computer peripheral, a computer peripheral having there on a touch screen user interface, and an activation control for activating and deactivating the touch screen interface. In one embodiment, the host computing system is a laptop computer and the computer peripheral is a universal serial bus device.

In one embodiment, the computer peripheral is a universal serial bus hub adapted also as a mouse pad, the mouse pad having thereon the touch screen interface. In one embodiment, the touch screen user interface is a 10-key calculator interface. In one embodiment, the control for activating and deactivating the touch screen interface is a button located on one of or both of the computer peripheral and the host computing appliance.

According to one embodiment of the invention, the computing system further includes a power transformer attached to the computer peripheral for providing power to the peripheral from alternating house current. In a variation of this embodiment, the computing system further includes a memory card slot and resident memory for storing software and for performing calculations.

In one embodiment, the computing system includes one or more batteries onboard the computer peripheral for providing power to the peripheral from the battery or batteries. In one embodiment, the touch screen interface is one of a resistive interface, a capacitive interface, or a surface acoustic wave interface.

In one embodiment, the computing system further includes software on the host computing appliance that enables a display of the touch screen interface and data results, the display occurring on the display monitor of the computing appliance. In a variation of the embodiments where batteries or a transformer provides power to the computer peripheral, the computing system further includes wireless communication circuitry on the computer peripheral and on the host computing appliance, the circuitry enabling wireless transfer of data from the peripheral to the host computing appliance.

According to another aspect of the present invention, a method for performing 10-key calculations using a computing system is provided, the computing system comprising a host computing appliance and a computer peripheral supporting a touch screen user interface representing a 10-key calculator. The method includes the acts (a) connecting the computer peripheral to the host computing appliance, (b) booting up the host computing appliance, (b) activating the touch screen user interface, and (c) performing at least one calculation by touching keys on the interface.

In one aspect of the method in act (a), the host computing appliance is a laptop computer and the computer peripheral is a universal serial bus device, the connection accomplished by a universal serial bus cable. In a variation of this aspect, the universal serial device is a mouse pad. In a further variation the mouse pad includes a universal serial bus hub.

In one aspect of the method in act (c), the touch screen interface is activated by a button on the computer peripheral or a button on the host computing appliance. In one aspect the touch screen interface is one of a resistive interface, a capacitive interface, or a surface acoustic wave interface.

In one aspect of the present invention, in act (a), the computer peripheral derives power from one or more batteries or from an alternating current through a transformer and the connection is a wireless connection enabled by wireless communication circuitry in the host computing appliance and in the computer peripheral. In another aspect of the method in act (b) activation of the touch screen interface also causes the computing appliance to display the touch screen interface including a results window, the display occurring on the display monitor of the computing appliance.

According to another aspect of the present invention, a mouse pad is provided. The mouse pad includes a mouse pad body, a universal serial bus interface, and a touch screen. In one embodiment, the touch screen is one of a resistive touch screen, a capacitive touch screen, or a surface acoustic wave touch screen. In a variation of this embodiment, touch screen is configured to represent a 10-key calculator user interface.

### BRIEF DESCRIPTION OF THE DRAWING FIGURES

FIG. 1 is a face view of a USB mouse pad with 10-key touch screen capability according to an embodiment of the present invention.

FIG. 2 is a sectioned view of the mouse pad of FIG. 1 taken generally along the section lines AA.

### DETAILED DESCRIPTION

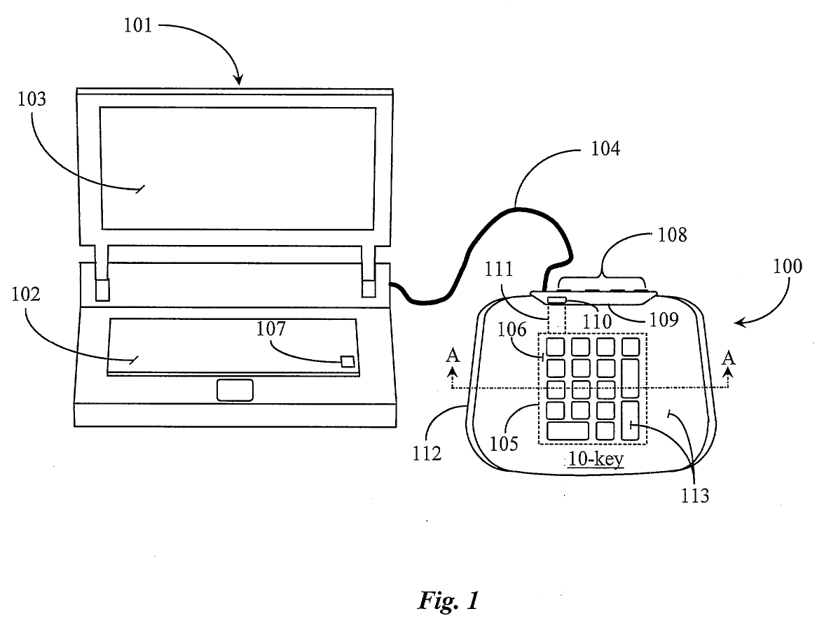

FIG. 1 is a face view of a USB mouse pad 100 with 10-key touch screen capability according to an embodiment of the present invention. Mouse pad 100 is also a universal serial bus (USB) hub and is illustrated in this example connected to a laptop computer 101 by way of a USB cable 104.

Laptop 101 is a typical computing appliance having at least one USB port (not visible in this example) for connecting USB cable 104. Laptop 101 includes a typical laptop screen 103 and a laptop keyboard 102.

A USB hub housing 109 is provided at one end of mouse pad 100 and contains all of the circuitry and USB ports to enable the hub. In this example, USB hub housing 109 derives power from laptop 101 via cable 104. In another embodiment, mouse pad 100 might include a power transformer and electrical plug so that it may be powered independently from laptop 101. In this embodiment, mouse pad 100 may also include wireless communication circuitry for communicating wirelessly to laptop computer 101 instead of using a cabled USB connection. In a variation of this embodiment, mouse pad 100 may derive power from rechargeable batteries instead of alternating current (AC).

USB hub 109 includes 4 high-speed USB ports 108 in this example, but may have fewer or more USB ports than are illustrated without departing from the spirit and scope of the present invention. USB hub housing 109 may be made of a durable polymer, metal, or other suitable materials. Hub 109 is affixed to, or may form to a mouse pad body 112. Mouse pad body 112 may be a hollow body in one embodiment. Mouse pad body 112 may be made of a transparent polymer in one embodiment. In this embodiment, hub 109 may include one or more lights (not illustrated) such as light emitting diodes (LEDs) for example, that when lit up may illuminate the edge of mouse pad body 112 so that it is visible in low-light conditions.

Mouse pad 100 has a solid-colored surface 113 provided thereto. Surface 113 may be a coating or a thin laminate layer of material that provides the basic operating surface for a computer mouse. The same solid surface may also be provided on the opposite side of mouse pad 100. The mouse pad surface may be a rubberized surface or some other smooth surface enabling typical mouse operation.

Mouse pad 100 in one embodiment comprises a 10-key touch screen 105. Touch screen 105 provides graphic representation of 10-key function keys generic to a 10-key computing system. It will be appreciated by one with skill in the art of 10-key systems that there are different configurations of basic 10-key systems where key description and key layout is concerned. Some systems have keys and functions that other systems lack. It is intended herein that at least the basic 10-key function keys be represented in this example. There may be more keys and features provided in 10-key touch screen 105 than are illustrated in this example.

In this example, the keys of 10-key touch screen 105 may be coated or laminated with a solid color material similar to or the same as material 113. A transparent pattern 106 defined by the absence of solid color 113 may be provided so that in the case of lighting during low light conditions, the 10-key touch screen 105 is highly visible when activated. Moreover, the symbols (not illustrated) that define each key in touch screen 105 may be transparent enabling them to be lighted when the interface is activated. Lighting may be refracted light or a backlighting system.

Touch screen 105, in this example a 10-key interface, may be activated from a button provided on the mouse pad, for example, button 110 located on hub 109. In the same or in another embodiment, the 10-key interface may be activated from the laptop computer, for example, by depressing a button 107 located on keyboard interface 102. In a preferred embodiment, 10-key interface 105 may be activated and deactivated without affecting USB ports 108 on USB hub 109.

10-key touch screen 105 may be implemented using one of several different touch screen technologies without departing from the spirit and scope of the present invention. In one embodiment screen 105 is a resistive touch screen. In another embodiment, screen 105 may be a capacitive touch screen. In still another embodiment, touch screen 105 may be a surface acoustic wave touch screen. The circuitry enabling touch screen 105 may be provided directly beneath the touch screen graphics (Keys). The circuitry may be provided in the form of a thin circuit board or a flexible circuit panel. In either case, the circuitry may be connected to USB hub 109 via a flat cable 111.

In this case, touch screen 105 operates as a USB peripheral but does not depend on any ports on hub 109. The USB cable 104 that powers hub 109 also powers touch screen 105. The touch screen software driver or drivers enabling recognition and operation of the screen may be installed on laptop 101.

In use of the system of the invention, a user may plug mouse pad 100 into the USB port of any computing device like laptop 101. A USB mouse may be plugged into one of USB ports 108 to enable mouse input control of laptop 101. Other USB devices may also be plugged into other USB ports 108 and used simultaneously with the mouse function. The mouse operates on the pad surface, which includes touch screen 105, and operating the mouse does not affect the touch screen when the touch screen is not activated. When the user desires, he or she may activate touch screen 105 by depressing button 110 on hub 109 or by depressing key 107 on laptop keyboard interface 102. An additional 10-key display supported by local software (not illustrated) may also be provided to display on laptop screen 103 when the 10-key is in use.

10-key touch screen 105 may be used like a traditional 10-key calculator; each key is assigned a function and may respond to the touch of a user. One with skill in the art will recognize that 10-key operation is best performed with direct touch (user fingers to keys). All three touch screen technologies described above support direct touch activation of the keys represented graphically on the touch screen surface. The mechanics of each touch screen type are well known and available to the inventor.

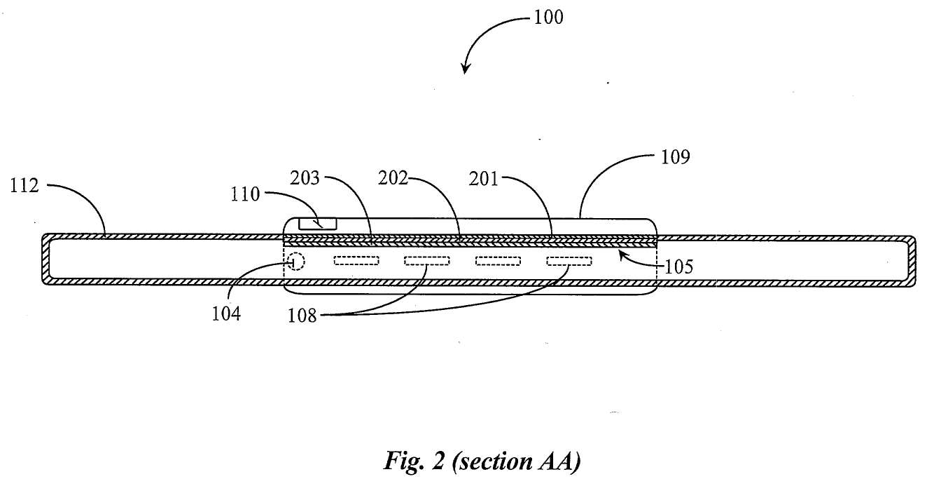

FIG. 2 is a sectioned view of mouse pad 100 of FIG. 1 taken generally along the section line A-A of FIG. 1. Mouse pad body 112 is more or less a hollow body in this example. This is not strictly required in order to practice the invention, as long as the body encloses the touch screen components and cable leading to hub 109. USB ports 108 and USB cable 104 are represented in broken line in this example. Touch screen activation button 110 is visible on the surface of hub 109.

In this example, touch screen 105 has a metallic surface resistive layer 201 that is substantially flush with the surface of mouse pad body 112. The touch screen surface panel may be a glass surface or a polymer surface depending on the type of architecture used. In this example, a conductive metallic touch screen layer 202 is provided directly beneath resistive surface 201. Layer 201 and layer 202 are spaced apart from one another by a small gap substantially equal in height over the inner facing planar surfaces. In one example of a touch screen interface, this represents a resistive touch screen system.

In one embodiment layer 201 (top layer) is a capacitive layer that holds a charge and layer 202 is a panel. This example would represent a capacitive touch screen technology. In still another embodiment, touch screen 105 is a surface acoustic wave system having transducers attached to the screen panel along the x and y axis. In this embodiment, there are no metallic layers.

The exact architecture and number of layers comprising the touch screen monitor depends on the type of system implemented. Optionally, touch screen 105 has a backlight panel 203 that may be a circuit board supporting one or more LEDs. In one embodiment, layer 203 is a flexible panel with light emitting chemicals that may be excited according to the introduction of an electric charge carried by traces within the panel. This type of backlight technology is known to and available to the inventor. In this embodiment, the transparent pattern including the symbols of the keys light up when touch screen 105 is activated so that it is easily visible in low light or even no light conditions.

One with skill in the art of touch screen configurations will recognize that a variety of sizes (measured diagonally across screen) of touch screens may be provided. When touch screen 105 is not activated, mouse pad 100 functions as a mouse pad and USB hub. However when activated, touch screen 105 lights up and may be operated like a traditional 10-key calculator. In one embodiment, all of the calculations resulting from operation of the 10-key system represented by touch screen 105 are performed on a host computing system like laptop 101 described above. In this embodiment, a duplicate 10-key interface with a result window may display on the display monitor of the host computing system while the 10-key interface is activated for use. Computer representation of a 10-key paper roll may also be provided in the computer display such that it may bear the calculations and results in sequential order as calculations are performed. This display may be scrollable and may be printed on a network or local printer connected to the host computing system.

In the embodiment described above, input from touch screen 105 is sent to the host computing system over the USB cable 104 and the input data is interpreted and results are calculated at the host computing system. In another embodiment, USB hub 109 also includes a microprocessor that can interpret input data and perform calculations locally before sending the resultant data to the host computing system. If mouse pad 100 has an onboard power supply like a battery or can be connected electrically to a power transformer, then the 10-key feature enabled by touch screen 105 may be operated while mouse pad 100 is not connected to a host system. Therefore data results of the 10-key operation may be saved on mouse pad 100 in a resident memory, perhaps provided in hub housing 109, and then uploaded to a host computing system over the USB connector cable when desired. In this embodiment, a smart memory card slot may also be provided on hub 109 that is adapted to accept a removable memory card. In some cases, the card may be removed from the mouse pad and then inserted into a like card slot of the host computing system to upload 10-key result data.

It will be apparent to the skilled artisan that the embodiments described above are exemplary of inventions that may have greater scope than any of the singular descriptions. It will also be apparent to one with skill in the art that the present invention may be provided and practiced using some of or all of the components described in the various embodiments and according to the various configurations without departing from the spirit and scope of the present invention. The spirit and scope of the present invention shall only be limited by the claims that follow.

What is claimed is:

1. A computing system for calculating comprising:
a host computing appliance able to communicate with a computer peripheral;
a computer peripheral comprising a touch screen user interface; and
an activation control for activating and deactivating the touch screen interface.

2. The computing system of claim 1, wherein the host computing system is a laptop computer and the computer peripheral is a universal serial bus device.

3. The computing system of claim 1, wherein the computer peripheral is a universal serial bus hub adapted also as a mouse pad, the mouse pad having thereon the touch screen interface.

4. The computing system of claim 1, wherein the touch screen user interface is a 10-key calculator interface.

5. The computing system of claim 1, wherein the control for activating and deactivating the touch screen interface is a button located on one of or both of the computer peripheral and the host computing appliance.

6. The computing system of claim 1, further including a power transformer attached to the computer peripheral for providing power to the peripheral from alternating house current.

7. The computing system of claim 6, further including a memory card slot and resident memory for storing software and for performing calculations.

8. The computing system of claim 1, further including one or more batteries onboard the computer peripheral for providing power to the peripheral from the battery or batteries.

9. The computing system of claim 1, wherein the touch screen interface is one of a resistive interface, a capacitive interface, or a surface acoustic wave interface.

10. The computing system of claim 1, further including software on the host computing appliance that enables a display of the touch screen interface and data results, the display occurring on the display monitor of the computing appliance.

11. The computing system of claims 6 and 8, further including wireless communication circuitry on the computer peripheral and on the host computing appliance, the circuitry enabling wireless transfer of data from the peripheral to the host computing appliance.

12. A method for performing 10-key calculations using a computing system comprising a host computing appliance and a computer peripheral supporting a touch screen user interface representing a 10-key calculator including the acts:
(a) connecting the computer peripheral to the host computing appliance;
(b) booting up the host computing appliance;
(b) activating the touch screen user interface; and
(c) performing at least one calculation by touching keys on the interface.

13. The method of claim 12, wherein in act (a), the host computing appliance is a laptop computer and the computer peripheral is a universal serial bus device, the connection accomplished by a universal serial bus cable.

14. The method of claim 13, wherein the universal serial device is a mouse pad.

15. The method of claim 14, wherein the mouse pad includes a universal serial bus hub.

16. The method of claim 12, wherein in act (c), the touch screen interface is activated by a button on the computer peripheral or a button on the host computing appliance.

17. The method of claim 12, wherein the touch screen interface is one of a resistive interface, a capacitive interface, or a surface acoustic wave interface.

18. The method of claim 12, wherein in act (a), the computer peripheral derives power from one or more batteries or from an alternating current through a transformer and the connection is a wireless connection enabled by wireless communication circuitry in the host computing appliance and in the computer peripheral.

19. The method of claim 12, wherein in act (b) activation of the touch screen interface also causes the computing appliance to display the touch screen interface including a results window, the display occurring on the display monitor of the computing appliance.

20. A mouse pad comprising:
a mouse pad body;
a universal serial bus interface; and
a touch screen.

21. The mouse pad of claim 20, wherein the touch screen is one of a resistive touch screen, a capacitive touch screen, or a surface acoustic wave touch screen.

22. The mouse pad of claim 20 wherein the touch screen is configured to represent a 10-key calculator user interface.
